(19) United States
(12) Patent Application Publication
(10) Pub. No.: US 2007/0006866 A1
(43) Pub. Date: Jan. 11, 2007

(54) Damper bracket for gas grill lids

(76) Inventor: Joseph O'Niell, Nicholson, PA (US)

Correspondence Address: Joseph O'Neill, RR2 2205 Pedrick Rd., Nicholson, PA, 18446, US

(21) Appl. No.: 11/429,702

(22) Filed: May 8, 2006

Related U.S. Application Data
(60) Provisional application No. 60/677,303, filed on Jul. 5, 2005.

(51) Int. Cl. F24B 3/00; F24C 3/00; A47J 37/00

(52) U.S. Cl. 126/25 R; 126/41 R

(57) ABSTRACT

The gas grill lid is supported by the damper bracket in selected open angles having notches or cutouts to be used for selected openings using a screw, pin or rivot mounted on the side of the gas grills.

### BACKGROUND OF INVENTION

### 1. Field of Invention

The invention relates to gas grills with lids on hinges, while gas grills have a lid that is limited to only two positions, as in the case of pivoted lids, either open or closed. It would be desirable to have a supplemental means of putting such lids in one or more intermediate positions, partially open for desirable cooking tempatures. The Damper Gas Grill Bracket gives you that option for cooking.

### SUMMARY OF INVENTION

The operation of this damper bracket is the lid moves freely up and down when not in use. When said damper bracket is to be used just pull the handle provided forward to to desired position and it locks into place. To release the engaged bracket just lift the lid and the damper bracket disengages riding on a screw, pin or rivot on the smooth surface of the inside rail opposite of the hooks or cutouts of the damper bracket. The only time you need to touch the damper bracket handle is when it is to be used to put into desired positions.

### BRIEF DESCRIPTION OF THE DRAWINGS

For better understanding of the invention, reference is made to the following drawings which are to be taken in conjuction with the detailed description to follow in which;

FIG. 1 Shows right side view of member of the present invention with the Gas Grill Lid of the cooking instrument in the closed position with the Damper Gas Grill Bracket mounted in place ready to use.

FIG. 1A Shows right side view of member of the present invention with the Gas Grill Lid in the open position using the Damper Gas Grill Bracket.

FIG. 2. Drawings of the Damper Gas Grill Bracket showing the areas for mounting and the use of said member.

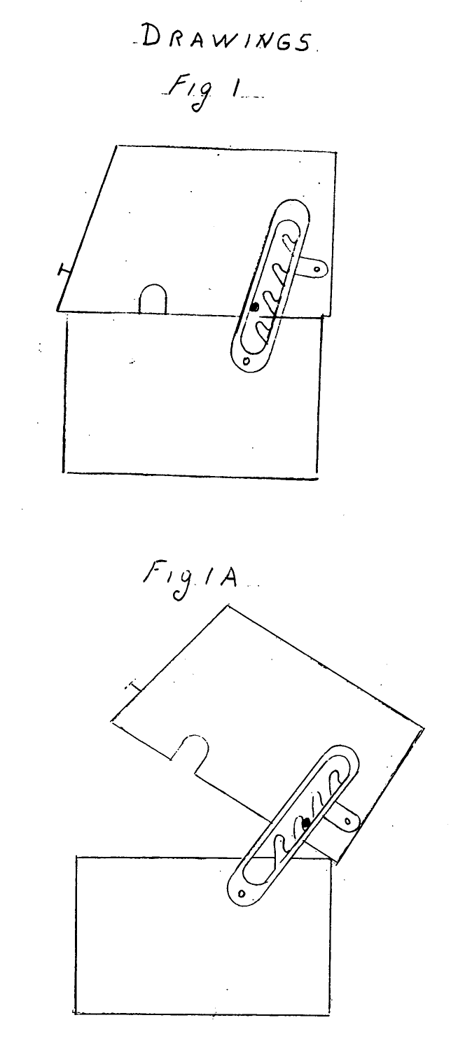

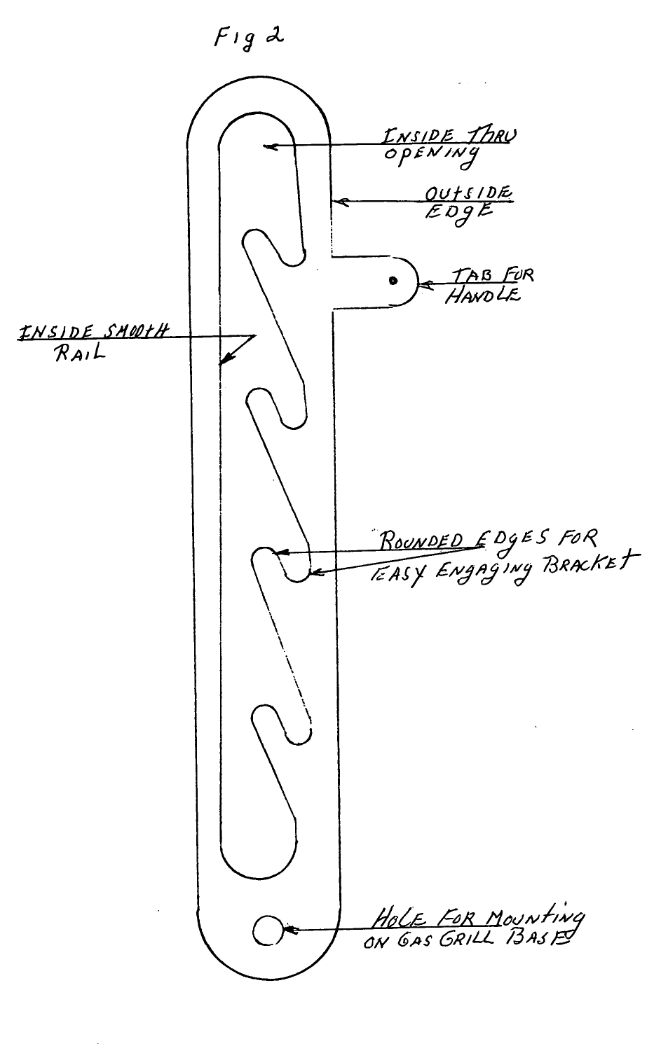

### DESCRIPTION

1. This member the Damper Gas Grill Bracket has an inside opening consisting of a smooth rail and notches or cutouts to be mounted on the side of a gas grill, such member is to be mounted on a approx. angle of 7 degrees using the hole and the inside opening to create the angle.

The opening at one end of the bracket is used as the adjustable end, and the hole provided is the statinery end.

2. This member consists of a thru opening, the inside front of bracket consists of a smooth surface called a rail for a screw, pin or rivot to ride on when the Damper Bracket is not engaged.

The opposite side of the smooth surface of the rail are notches or cutouts for the engaging of bracket to put the Gas Grill Lid into different cooking positions by using the handle provided.

To disengage the bracket just lift the lid and the bracket disengages and now rides on the smooth surface of inside rail.

3. The Gas Grill Bracket is for gas grills with hinges on the lid and base. This Damper Gas Grill Bracket is an added feature for cooking and gives you the option of controlling the heat.

I claim:

1. The Damper Gas Grill Bracket is consisting of a member with a handle and an opening thru the inside of such member, consisting of notches or cutouts to put Gas Grill Lids with hinges in a desired opening for cooking and an inside smooth surface called a rail.

2. As stated in claim 1 said notches or cutouts having a rounded edges for easy transition of Damper Gas Grill Bracket to lock into desired position.

3. As stated in claim 2 said notches or cutouts are only used when engaging the Damper Gas Grill Bracket.

4. As stated in claim 3 to engage member for desired opening of Gas Grill Lid just pull the provided handle forward and said member engages the Gas Grill Lid into desired position. When said member engages it said notches or cutouts rest on a screw, pin or screw at desired position.

5. As stated in claim 4 when said screw, pin or rivot is used to engage said member they can be either attched to the lid or base for positing.

6. As stated in claim 5 when Damper Gas Grill Bracket is not being used the Bracket rides on a screw, pin or rivot in the opening of the said member on the smooth surface of the inside rail.

7. As stated in claim 6 said rail is on the inside of opening in said member with a smooth surface for lid to move freely up and down.
